(19) United States
(12) Patent Application Publication
(10) Pub. No.: US 2013/0036978 A1
(43) Pub. Date: Feb. 14, 2013

(54) SYSTEM FOR OPERATING A REMOTE DEVICE

(71) Applicants: Glenn Morris, Burnet, TX (US); Warren Kent Turner, Cloudcroft, NM (US)

(72) Inventors: Glenn Morris, Burnet, TX (US); Warren Kent Turner, Cloudcroft, NM (US)

(73) Assignee: GLENN MORRIS, Burnet, TX (US)

(21) Appl. No.: 13/205,887

(22) Filed: Aug. 9, 2011

(51) Int. Cl. A01K 5/02; G08B 1/00

(52) U.S. Cl. 119/51.11; 340/309.8

(57) ABSTRACT

A system for operating a remote device has a portable timer module employing a microcontroller with an operating system configured to read and store executable instructions and data received over a communications link. A software application program in a personal computing device enables a user to select time of day control times for operating the remote device. The microcontroller receives the user-selected time of day control time data and instructions when coupled to the personal computing device. The microcontroller emulates the function of a time of day clock and generates control signals when the emulated time of day clock corresponds to the user-selected time of day control times. The portable timer module has a battery pack for powering the microcontroller. The portable timer module is configured to selectively couple battery voltage from the remote device to activate one or more of its electromechanical devices in response to the control signals.

### TECHNICAL HELD

This invention relates in general to a method and system for operating a remote device, and more particularly to remotely operating a game feeder.

### BACKGROUND

A remote device such as a game feeder (e.g., a deer feeder) requires periodic activation to enable it to deliver its function: providing feed for game to attract them for harvest. Game feeders are typically battery operated and have an electrically activated system for delivering feed. To be effective, it is desirable to deliver feed at programmed times so that the game in become acclimated to the feeding times making them easier to harvest. Previous systems include those that simply detect when it is daylight using a photo-sensor, which activates an electric motor via a relay, which then operates for a predetermined time to deliver feed (e.g., by spreading it on the ground). Other systems that allow more elaborate time setting options have push activated buttons and a visual display of some sort as a means of setting and verifying programmed times. However, such control and display circuitry adds additional electrical loading, which causes a further drain on the battery life. Additionally, visual displays are expensive and make it more difficult to seal the unit against the effects of weather (such feeders are typically installed in remote wilderness).

### SUMMARY

Herein is disclosed a more power efficient, low cost way of providing a timer function for a remote device such as a game feeder. A system for generating timing control signals for a remote device comprises a battery-powered portable timer module having a microcontroller programmed to emulate a time of day clock and receive time of day control times when coupled to a personal computing device (“PCD”) having a time of day clock (an electronic circuit or software that maintains the time of day in an electronic device). The PCD is configured to execute an application program that enables a user to select time of day control times. An operating system loaded into the microcontroller interprets and stores the time of day control times and allows the portable timer module to synchronize its emulated clock with the PCD time of day clock. The system has an interface connector for electrically coupling a high power source and an electromechanical device in the remote device to the portable timer module. An electrically controlled power switch directs power from the high power source to the electromechanical device in response to control signals generated by the microcontroller in turn generated in response to the user-selected time of day control times. The portable timer module may include a cycle switch that allows an operator to manually cycle the microcontroller to generate control signals for test operation of the remote device.

### BRIEF DESCRIPTION OF DRAWINGS

FIG. 1 illustrates a block diagram of a system incorporating a portable timer module according to embodiments described herein; and

FIG. 2 illustrates a flow diagram of method steps controlling a remote device from a portable timer module according to embodiments described herein.

### DETAILED DESCRIPTION

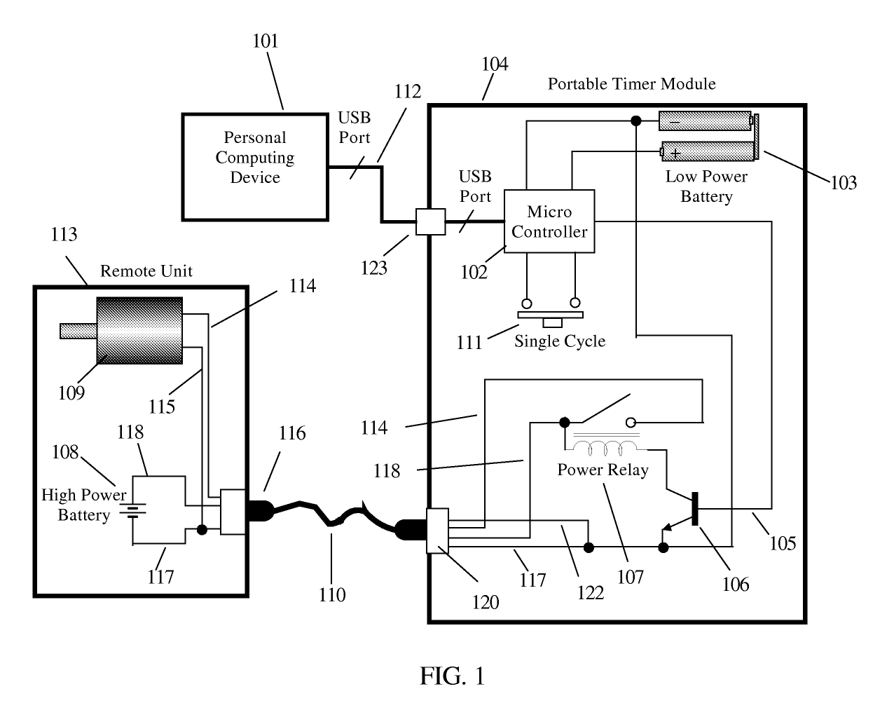

FIG. 1 illustrates a block diagram of a system incorporating a self-contained portable timer module (“PTM”) 104. The personal computing device (“PCD”) 101 may be any general purpose device that runs a software application program and generates and communicates the data 112 at a USB port 123, or other data communication port, including, but not limited to, a wireless communications link. The PCD 101 may include, but is not limited to, a personal computer (“PC”), a smart phone, an iPod, personal data assistant (“PDA”), tablet computer, or other media player. The PCD 101 may be programmed or loaded with a software application program capable of generating program steps executable in a microcontroller (“MC”) 102. The programming data may be unidirectional from the PCD 101, or it may be bidirectional so the PTM 104 may send data to the PC 101 or respond by verifying the programming for error detection.

The MC 102 may be loaded with an operating system that is suitable to interpret the program steps and generate at least one control signal, for example, a pulse sequence where the pulse width corresponds to desired start and stop times for the remote device 113 (e.g., a game feeder). Such a game feeder 113 may be a remote deer feeder such as disclosed in U.S. Pat. No. 7,479,624 and U.S. patent application Ser. No. 11/550,310, which are hereby incorporated by reference herein. The pulse sequence may be synchronized with the time of day wherein the MC 102 is programmed to emulate the function of a time of day clock that is set to a desired time of day and synchronized by the PCD 101. Once set, the MC 102 has program steps that emulate a time of day clock with the ability to instigate an action at a programmed time(s) of day and continue that action for a programmed amount of time or until a programmed stop time. The MC 102 would continue its operation as long the low power battery (“LPB”) 103 has sufficient energy. The LPB may comprise one or more small battery cells (e.g., watch-like, A, AA, AAA, C, D size batteries). A manually activated pushbutton switch 111 (which is optional) may be used to commence a single cycle in the MC 102 as a test function, overriding the time of day clock start and stop times. In an embodiment, when the LPB 103 is replaced, the MC 102 has a power-on-reset function that resets the time of day clock function to a predetermined time (e.g., 12:00 p.m.). In this manner, a user may synchronize the time of day clock function in the PTM 104 without having access to a PCD 101. This would require waiting until the predetermined time before changing batteries. The PTM 104 is self-contained, meaning that it is enclosed within its own packaging or enclosure, which may be made of plastic or metal, for example, which protects the PTM 104 contents from the external environment. This is advantageous since the PTM 104 will be connected to the remote device 113, which may be in a wilderness area exposed to the weather. The self-contained PTM 104 further means that it operates on its own power source 103, and that it is programmed with signals it receives through the communications port 123 after which it is then disconnected from the PCD 101, and then it is connected to the remote device 113, where it provides the timing control signals through its communications port 120. In this sense, the PTM 104 is portable between the PCD 101 and the remote device 113.

In an embodiment of FIG. 1, the MC 102 generates a control signal 105 (e.g., a low power control signal) that is coupled to a transistor 106. The transistor 106 provides a drive current for activating a power switch, in this embodiment a power relay 107. When the control signal 105 has a value of a logic one (e.g., a positive voltage), the transistor 106 is switched ON, which in turn closes the contact(s) on the power relay 107, coupling the positive terminal 118 of a high power battery 108 to an appropriate terminal (e.g., 114) of controlled device 109 (for example, an electric motor or other electromechanical device). The low power control signal 105 thereby controls the power relay 107 such that current from the high power battery 108 operates the device 109. In an embodiment, the terminal 114 of the electric motor 109 is connected via a cable 110 and a connector 120 to a terminal of the power relay 107. The positive terminal 118 of the high power battery 108 is connected to the other terminal of the power relay 107. The low voltage terminal 117 of the high power battery 108 is connected to the emitter of the transistor 106 and the low voltage terminal of the low power battery 103. The high power battery 108 may be a battery cell with sufficient power to operate an electromechanical device sufficient to perform a work function, such as the spreading of animal feed over a large area of ground (for example, as described in the aforementioned patent and patent application incorporated by reference).

While FIG. 1 illustrates an embodiment with one control signal, the PTM 104 may generate multiple control signals (such as 105) that occur at times selected by a user of the PCD 101. The user's selection(s) are loaded into the microcontroller 102, which is configured to execute instructions emulating a time of day clock that may be synchronized with the time of day clock in the PCD 101. The remote device 113 may be coupled to the PTM 104 while at a base location before it is transported to a remote location. This allows the PTM 104 to be low cost without the need for a visual display, manual push button(s), etc. required in many prior art remote devices having integrated programmable timer functions.

FIG. 1 illustrates an embodiment where the power control switch 107 for coupling the high power battery 108 to the device 109 resides in the PTM 104. Alternatively, the power control switch 107 may reside in the remote device 113 and still be within the scope of the present invention. Embodiments herein use the low power battery 103 to power low current devices, and the high power battery 108 to power high current devices.

Other possible methods of communicating with and programming the PTM 104 include the use of signals granted as sound, radio frequency signals, and electromagnetic signals (e.g., light waves). A USB-to-serial convertor may be in the programming cable or in the circuitry of the PTM 104. When sound is used, a convertor circuit (e.g., a modem) may be used to communicate with the PCD 101. A telephone land line or cellular connection may communicate program data to the PTM 104 from a distant location. Radio frequency signals may utilize WiFi, Bluetooth, or a wireless transceiver to communicate with the PTM 104.

When electromagnetic waves are used, a long range light beam such as a laser, a fiber optic cable, or a docking station that uses an optical communication link may be used. A special program may flash the display screen on the PCD 101 in a binary pattern, wherein a photo-sensor connected to the PTM 104 may convert the screen flash to programming data. A docking station, with an optical connection would allow the PTM 104 to be programmed without connecting an electrical cable.

In another embodiment, a special module (not shown), which stores a program internally, may be used to program timers like the PTM 104 without a need to carry a computing device like the PCD 101 into the field. The PCD 101 would be used to upload program data to the special module and then the special module would connect to the PTM 104 (in place of the PCD 101) to send the program data. The special module may also be used to update the time of day clock in the PTM 104. The PTM 104 may keep the time of day as well as the day of the week so events may be programmed to occur on certain specific days instead of occurring every day.

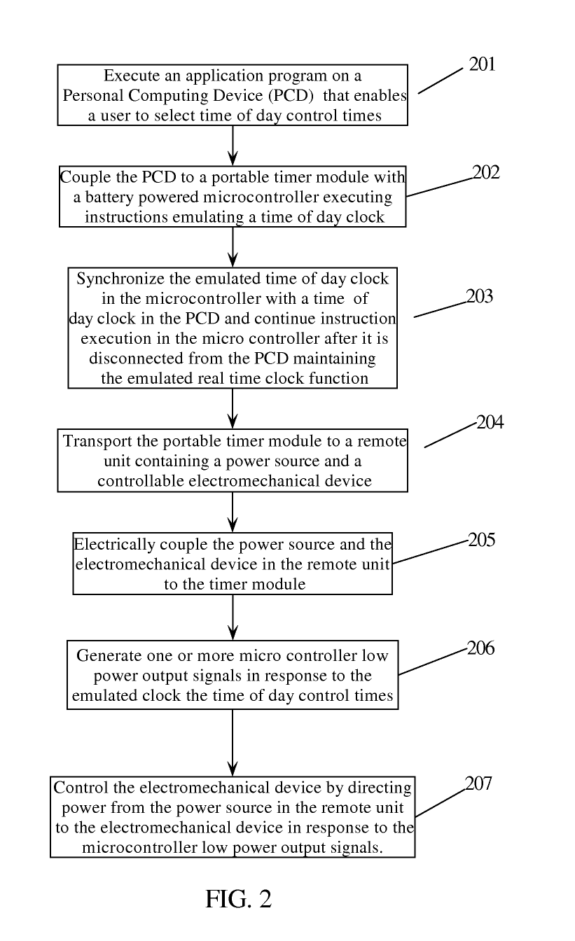

FIG. 2 illustrates a flow diagram of method steps used in embodiments herein, such as the system in FIG. 1. In step 201, an application program is executed in a personal computing device (“PCD”) 101 that enables a user to select time of day control times. In general, these control times correspond to start and stop times for operation of a device 113. These control times may be repeated at regular intervals or may be non-repetitive with multiple time of day start times and corresponding duration time(s) or time of day stop time(s). In step 202, the PCD 101 is coupled to a PTM 104 which has a battery-powered (103) microcontroller 102 configured to execute program instructions emulating a time of day clock and instructions for recognizing the time of day control time(s) and outputting a control signal(s) in response to the control time(s). In step 203, the emulated time of day clock is synchronized with a clock in the PCD 101 and continues to emulate the time of day clock after disconnect from the PCD 101. In step 204, the PTM 104 is transported to a remote device 113 containing a high power source (108) and at least one electromechanical device (e.g., 109). In step 205, the high power source 108 and the electromechanical device 109 are electrically coupled to the PTM 104. In step 206, the microcontroller 102 generates one or more low power control signals 105 in response to the user programmed control times and the emulated time of day clock. In step 207, the electromechanical device 109 is controlled by directing power from the high power source 108 to the electromechanical device 109 in response to the low power control signals 105.

In an embodiment, the device 113 is a remote game feeder as previously disclosed herein which spreads feed pellets on the ground with a spreader operated by an electric motor 109, which starts and stops in accordance with the programmed time of day settings.

What is claimed is:

1. A system for generating timing signals for controlling a remote device comprising a self-contained timer module comprising:
circuitry configured to electronically receive time of day control time data from a source external to the self-contained timer module via a first communications port;
circuitry configured to generate an emulated time of day clock and generate a control signal when the time of day control time data corresponds to a selected time of day of the emulated time of day clock;
an interface connector for electrically coupling the remote device to the self-contained timer module; and
circuitry configured to send a timer signal a response to the control signal to the remote device via a second communications port.

2. The system of claim 1, further comprising an electrically controlled switch configured to generate the timer signal for directing power from a high power source to an electromechanical device of the remote device in response to the control signal.

3. The system of claim 2, further comprising a personal computing device configured to run an application program enabling a user to select time of day control times that generate the time of day control time data.

4. The system of claim 3, wherein the self-contained timer module further comprises a single cycle switch for manually generating signals to test the remote device.

5. The system of claim 3, wherein the remote device is a game feeder.

6. The system of claim 3, wherein a power-on-reset of the self-contained timer module restarts the emulated time of day clock at a predetermined time.

7. The system of claim 1, wherein the interface connector couples at least one conductor to electrically reference the remote device and the self-contained timer module.

8. The system of claim 2, wherein the electrically controlled switch physically resides in the self-contained timer module.

9. A method for generating timing control signals for a remote device comprising:
executing an application program on a personal computing device that enables a user to select time of day control times;
coupling the personal computing device to a self-contained portable timer module having a battery-powered microcontroller executing instructions emulating a time of day clock;
during a time period when the personal computing device is coupled to the portable timer module, receiving the user-selected time of day control times and synchronizing the emulated time of day clock in the microcontroller with a time of day clock operating in the personal computing device;
at an end of the time period, transporting the portable timer module, while maintaining operation of the synchronized emulated time of day clock function with power from a battery, to the remote device containing a high power source and an electromechanical device;
electrically coupling the remote device to the portable timer module;
after electrically coupling the remote device to the portable timer module, generating a control signal in the microcontroller in response to the emulated time of day clock and the user-selected time of day control times; and
controlling operation of the electromechanical device by directing power from the high power source to the electromechanical device in response to the microcontroller-generated control signal.

10. The method of claim 9, wherein the personal computing device sends the instructions and data to the microcontroller over a communications link.

11. The method of claim 9, wherein the portable timer module comprises a single cycle switch for manually generating control signals to test the remote device.

12. The method of claim 9, wherein the remote device is a game feeder located in a remote wilderness area.

13. The method of claim 9, further comprising performing a power-on-reset of the portable timer module to restart the emulated time of day clock at a predetermined time.

14. The method of claim 10, wherein the communications link is a universal serial bus.

15. The method of claim 11, wherein there is a delay time from when the single cycle switch is activated until a control signal is generated allowing a user to move away from the remote device as a safety precaution.

16. The method of claim 9, wherein the electrical coupling of the remote device to the portable timer module includes an interface connector coupling a conductor to electrically reference the remote device and the portable timer module.

17. The method of claim 9, wherein the controlling of the electromechanical device includes automatically activating a switch in response to the microcontroller-generated control signal, wherein the switch physically resides in the portable timer module.
